(19) United States
(12) Patent Application Publication
(10) Pub. No.: US 2022/0314938 A1
(43) Pub. Date: Oct. 6, 2022

(54) COMPRESSOR UNIT

(71) Applicant: KABUSHIKI KAISHA KOBE SEIKO SHO (KOBE STEEL, LTD.), Hyogo (JP)

(72) Inventors: Daisuke WADA, Takasago-shi (JP); Naofumi KANEI, Takasago-shi (JP)

(73) Assignee: KABUSHIKI KAISHA KOBE SEIKO SHO (KOBE STEEL, LTD.), Hyogo (JP)

(21) Appl. No.: 17/687,401

(22) Filed: Mar. 4, 2022

(30) Foreign Application Priority Data
Mar. 30, 2021 (JP) 2021-056538

(51) Int. Cl. B60S 5/02; F04B 41/02; F17C 5/00; F17C 5/06; F17C 13/00

(52) U.S. Cl. CPC B60S 5/02; F04B 41/02; F17C 5/007; F17C 5/06; F17C 13/002; F17C 2205/0111; F17C 2205/0142; F17C 2205/0376; F17C 2221/012; F17C 2223/0123; F17C 2223/033; F17C 2225/0123; F17C 2225/036; F17C 2227/0164; F17C 2227/0344; F17C 2227/0348; F17C 2227/0353; F17C 2227/0355; F17C 2227/0388

(57) ABSTRACT

A compressor unit includes: a reciprocating compressor main body having a drive portion and a compression portion driven by the drive portion to compress a hydrogen gas; an electric motor that is a power source of the drive portion; a hydrogen supply flow path which is connected to a suction side flow path and to the compressor main body and through which a hydrogen gas flows; a fuel cell module that is disposed in the hydrogen station, generates electric power using a hydrogen gas guided through the hydrogen supply flow path, and supplies the generated electric power to the electric motor; and an inverter that adjusts a rotation speed of the electric motor.

### FIELD OF THE INVENTION

The present invention relates to a compressor unit.

### BACKGROUND ART

As disclosed in JP 2015-232384 A, a compressor unit installed in a hydrogen station to compress a hydrogen gas is conventionally known. In the hydrogen station disclosed in JP 2015-232384 A, the compressor unit is configured with a reciprocating compressor including a compression portion and a drive portion for driving the compression portion.

Since it is a common practice that a drive portion of a compressor unit is driven by an electric motor, an external power source such as a system power source is required to operate the compressor unit.

### SUMMARY OF THE INVENTION

An object of the present invention is to make it possible to operate a compressor unit in a hydrogen station without being connected to an external power source.

A compressor unit according to one aspect of the present invention is a compressor unit used in a hydrogen station and for compressing a hydrogen gas, the compressor unit including: a reciprocating compressor main body having a drive portion and a compression portion driven by the drive portion to compress a hydrogen gas; an electric motor that is a power source of the drive portion; a hydrogen supply flow path which is connected to a suction side flow path of the compressor main body or to the compressor main body and through which a hydrogen gas flows; a fuel cell module, disposed in the hydrogen station, for generating electric power using a hydrogen gas guided through the hydrogen supply flow path, and for supplying the generated electric power to the electric motor; and an inverter for adjusting a rotation speed of the electric motor.

### BRIEF DESCRIPTION OF THE DRAWINGS

FIG. 1 is a diagram schematically illustrating a hydrogen station according to an embodiment;

FIG. 2 is a diagram schematically illustrating a configuration of a compressor unit provided in the hydrogen station;

FIG. 3 is a diagram for explaining configurations of a first compression stage, a third compression stage, and a distance piece in the compressor unit;

FIG. 4 is a diagram for explaining a configuration of a fuel cell module provided in the compressor unit;

FIG. 5 is a diagram schematically illustrating a hydrogen station according to a modification; and

FIG. 6 is a diagram schematically illustrating a hydrogen station according to a modification.

### DESCRIPTION OF EMBODIMENTS

In the following, embodiments of the present invention will be described in detail with reference to the drawings.

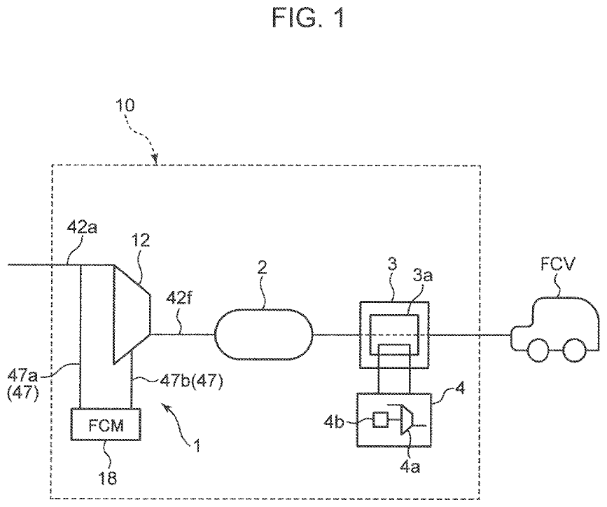

A hydrogen station 10 according to the present embodiment is a facility for supplying a hydrogen gas to a fuel cell vehicle FCV. As illustrated in FIG. 1, the hydrogen station 10 includes a compressor unit 1 for compressing a hydrogen gas, an accumulator 2 for storing a high-pressure hydrogen gas compressed by the compressor unit 1, and a dispenser 3 for receiving supply of the high-pressure hydrogen gas from the accumulator 2 to supply the high-pressure hydrogen gas to a hydrogen gas tank provided in a fuel cell vehicle FCV or the like.

A vapor compression type refrigerator 4 having a refrigerant gas compressor 4a is connected to the dispenser 3. The refrigerant gas compressor 4a is driven by a motor 4b. The dispenser 3 includes a cooling portion 3a for cooling a hydrogen gas flowing in the dispenser 3 by cold supplied by the refrigerator 4. The cooling portion 3a may be configured to directly exchange heat between a refrigerant flowing in the refrigerator 4 and the hydrogen gas, or may be configured to exchange heat between the refrigerant and the hydrogen gas via a brine circulating through a brine circuit (not illustrated).

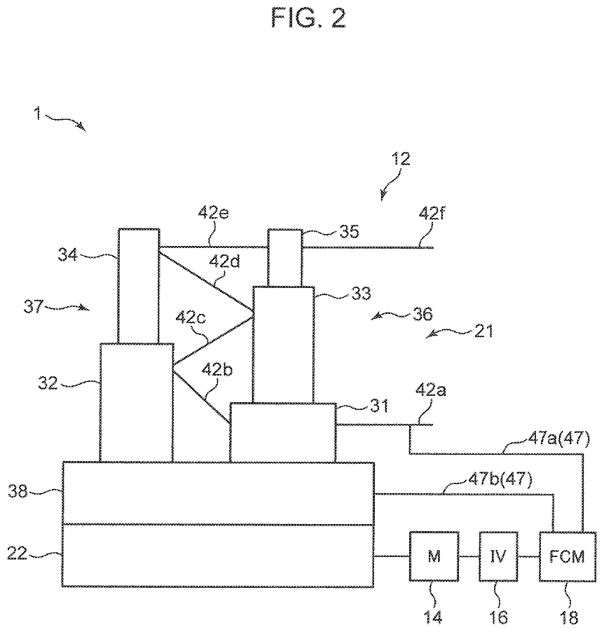

As illustrated in FIG. 2, the compressor unit 1 includes a compressor main body 12, an electric motor 14, an inverter 16, and a fuel cell module 18. The compressor main body 12 is configured with a reciprocating compressor, and includes a compression portion 21 and a drive portion 22 for driving the compression portion 21. The drive portion 22 has a crank mechanism (not illustrated). The electric motor 14 is an electric motor that drives the crank mechanism by supply of electric power. The inverter 16 adjusts a rotation speed of the electric motor 14. The fuel cell module 18 generates electric power for driving the electric motor 14.

The compression portion 21 includes a first block portion 36 having a plurality of compression stages 31, 33, and 35, a second block portion 37 provided separately from the first block portion 36 and having a plurality of compression stages 32 and 34, and a distance piece 38 disposed under the first block portion 36 and the second block portion 37. The first block portion 36 is provided with a first compression stage 31, a third compression stage 33, and a fifth compression stage 35, and the second block portion 37 is provided with a second compression stage 32 and a fourth compression stage 34. In the first to fifth compression stages 31 to 35, a hydrogen gas is compressed in the order of the first to fifth compression stages 31 to 35 as a crankshaft (not shown) of the drive portion 22 rotates.

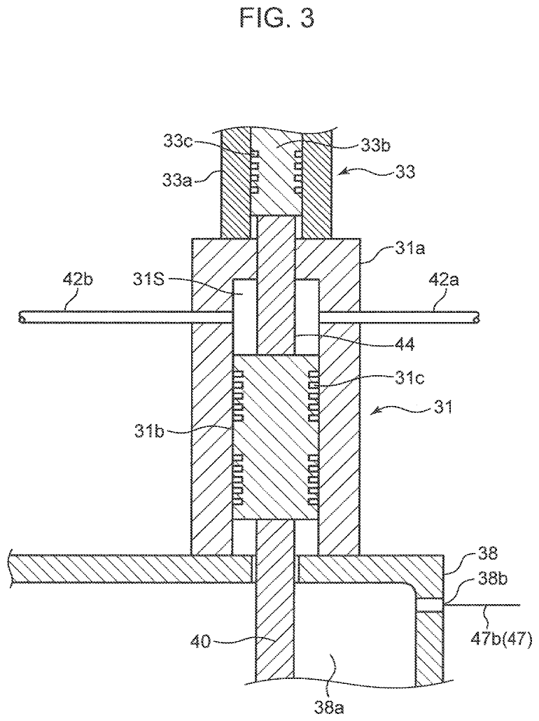

In the first block portion 36, the third compression stage 33 is placed on the first compression stage 31, and the fifth compression stage 35 is placed on the third compression stage 33. The first compression stage 31, the third compression stage 33, and the fifth compression stage 35 are configured as a so-called tandem structure compressor in which pistons of the respective stages are connected in series to one piston rod 40 (see FIG. 3). On the other hand, in the second block portion 37, the fourth compression stage 34 is placed on the second compression stage 32. The second compression stage 32 and the fourth compression stage 34 are configured as a so-called tandem compressor in which pistons (not illustrated) of the respective stages are connected in series to one piston rod (not illustrated).

The compression portion 21 includes a suction side flow path 42a, a first connection path 42b, a second connection path 42c, a third connection path 42d, a fourth connection path 42e, and a discharge path 42f. The suction side flow path 42a is connected to a suction port of the first compression stage 31, and a hydrogen gas suctioned into the first compression stage 31 flows through the suction side flow path 42a. The hydrogen gas suctioned into the first compression stage 31 has a pressure of less than 2 MPa. The first connection path 42b connects the first compression stage 31 and the second compression stage 32 to each other, and a hydrogen gas compressed in the first compression stage 31 flows through the first connection path 42b. The second connection path 42c connects the second compression stage 32 and the third compression stage 33 to each other, and a hydrogen gas compressed by the second compression stage 32 flows through the second connection path 42c. The third connection path 42d connects the third compression stage 33 and the fourth compression stage 34 to each other, and a hydrogen gas compressed in the third compression stage 33 flows through the third connection path 42d. The fourth connection path 42e connects the fourth compression stage 34 and the fifth compression stage 35 to each other, and a hydrogen gas compressed in the fourth compression stage 34 flows through the fourth connection path 42e. The discharge path 42f is connected to a discharge port of the fifth compression stage 35, and a hydrogen gas compressed in the fifth compression stage 35 flows through the discharge path 42f. The suction side flow path 42a, the first connection path 42b to the fourth connection path 42e, and the discharge path 42f form a flow path through which a hydrogen gas flows. The suction side flow path 42a may be provided with a tank (not shown) for temporarily storing a hydrogen gas.

FIG. 3 partially and schematically illustrates configurations of the distance piece 38, the first compression stage 31, and the third compression stage 33. The first compression stage 31 includes a first cylinder 31a and a first piston 31b inserted into the first cylinder 31a. A plurality of piston rings 31c is mounted on an outer peripheral surface of the first piston 31b. The piston ring 31c seals between the first piston 31b and the first cylinder 31a. The first cylinder 31a and the first piston 31b define a first compression chamber 31S inside the first cylinder 31a. The hydrogen gas in the first compression chamber 31S is compressed by operation of the first piston 31b.

The third compression stage 33 includes a third cylinder 33a placed on the first cylinder 31a and a third piston 33b inserted into the third cylinder 33a. A third compression chamber (not shown) is formed inside the third cylinder 33a by the third cylinder 33a and the third piston 33b. A plurality of piston rings 33c is mounted on an outer peripheral surface of the third piston 33b. The third piston 33b has a diameter smaller than a diameter of the first piston 31b. The first piston 31b and the third piston 33b are connected to each other by a connection rod 44.

The first cylinder 31a is disposed on the distance piece 38. In other words, one end portion of the first cylinder 31a is connected to the distance piece 38. The distance piece 38 is disposed between the first cylinder 31a and the drive portion 22 and between a cylinder of the second compression stage 32 and the drive portion 22. In the distance piece 38, a space 38a for housing a leak gas that has leaked through a minute gap between the piston ring 31c and the first cylinder 31a is formed. In other words, a leak gas leaking from the first compression chamber 31S of the first compression stage 31, which is the compression stage located closest to the drive portion 22, is housed in the space 38a. As will be described later, the leak gas is supplied to the fuel cell module 18 as a drive source of the fuel cell module 18.

The distance piece 38 is provided with a supply path connection portion 38b for supplying the leak gas in the space 38a to a hydrogen supply flow path 47 (a compressed gas flow path 47b) to be described later. In other words, the hydrogen gas is recovered from the distance piece 38. The supply path connection portion 38b is configured with a through hole which penetrates a side wall of the distance piece 38 and to which the compressed gas flow path 47b is connected. Instead of the configuration in which a hydrogen gas is recovered from the distance piece 38, or together with the configuration in which a hydrogen gas is recovered from the distance piece 38, a configuration in which a hydrogen gas in the drive portion 22 is recovered may be adopted. In this case, a filter (not illustrated) or the like for removing oil is installed.

A piston rod 40 connected to the first piston 31b vertically penetrates the distance piece 38. The piston rod 40 converts rotational motion of the crankshaft of the drive portion 22 into reciprocating motion of the first piston 31b via a crosshead (not illustrated). Although not illustrated, the piston in the second compression stage 32 vertically penetrates the distance piece 38 as well.

Although not illustrated, the fifth compression stage 35 includes a fifth cylinder and a fifth piston inserted into the fifth cylinder. The fifth cylinder is placed on the third cylinder 33a. The fifth piston and the third piston 33b are connected by a connection rod (not illustrated). The second compression stage 32 and the fourth compression stage 34 have a configuration in which a piston is disposed inside a cylinder, and a fourth cylinder is placed on a second cylinder.

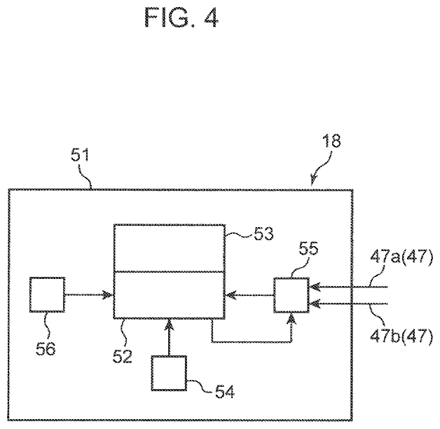

FIG. 4 shows a schematic configuration of the fuel cell module 18. The fuel cell module 18 has a configuration in which an FC stack 52, a boost converter 53, an air compressor 54, a hydrogen gas pump 55, and a cooling water pump 56 are housed in a housing 51. The FC stack 52 generates electric power by causing oxygen contained in air supplied from the air compressor 54 to react with a hydrogen gas supplied from the hydrogen gas pump 55 under a high-temperature environment. The boost converter 53 is configured to boost a voltage of the electric power generated by the FC stack 52. The cooling water pump 56 supplies cooling water to the FC stack 52.

The electric power boosted by the boost converter 53 is supplied to the electric motor 14 and the motor 4b of the refrigerant gas compressor 4a as an output of the fuel cell module 18. In other words, the fuel cell module 18 is used as both a power source of the electric motor 14 and a power source of the motor 4b of the refrigerant gas compressor 4a. While the fuel cell module 18 is used as a power source of the electric motor 14, electric power from another power source may be supplied to the motor 4b of the refrigerant gas compressor 4a.

The hydrogen supply flow path 47 through which a hydrogen gas flows is connected to the fuel cell module 18. In other words, the hydrogen supply flow path 47 is a flow path for supplying a hydrogen gas for use for power generation in the fuel cell module 18 to the fuel cell module 18.

As shown in FIG. 2, the hydrogen supply flow path 47 includes a suction gas flow path 47a connected to the suction side flow path 42a which is a flow path of a hydrogen gas suctioned into the compressor main body 12, and a compressed gas flow path 47b connected to the compressor main body 12. A hydrogen gas before being introduced into the compressor main body 12 flows through the suction gas flow path 47a. For example, a hydrogen gas of less than 2 MPa flows through the suction gas flow path 47a. Of the hydrogen gas introduced into the compressor main body 12, a hydrogen gas (leak gas) leaking from the first compression chamber 31S flows through the compressed gas flow path 47b. For example, a hydrogen gas of less than 2 MPa flows through the compressed gas flow path 47b. The hydrogen gas pump 55 suctions a hydrogen gas from the suction gas flow path 47a and the compressed gas flow path 47b, and sends the hydrogen gas toward the FC stack 52. In addition, the hydrogen gas pump 55 suctions a hydrogen gas that has not been used in the FC stack 52 and again sends out the hydrogen gas to the FC stack 52.

As described above, in the compressor unit 1 according to the present embodiment, electric power generated by the fuel cell module 18 disposed in the hydrogen station 10 is supplied to the electric motor 14, so that the compression portion 21 of the compressor main body 12 is driven using the electric motor 14 as a power source. At this time, the rotation speed of the electric motor 14 is adjusted by the inverter 16. Since the fuel cell module 18 disposed in the hydrogen station 10 is used as a driving power source, it is not necessary to connect to an external power source to drive the compressor main body 12.

If the compressor unit 1 is to be driven by an external power source, there may occur a case, for example, where a power receiving facility exceeding 400 V 100 kW is required. Coping with this case by newly installing or adding such a power receiving facility involves an installation space and cost. By contrast, in the present embodiment, the compressor unit 1 can be operated in the hydrogen station 10 without being connected to an external power source. Furthermore, since a hydrogen gas is supplied from the suction side flow path 42a or the compressor main body 12 to the fuel cell module 18, it is not necessary to supply a hydrogen gas from the outside in order to generate electric power.

In addition, since in the present embodiment, the leak gas from the first compression chamber 31S is supplied to the compressed gas flow path 47b via the supply path connection portion 38b, a hydrogen gas that has been conventionally discarded can be effectively used for power generation. In the compression portion 21, apart of the hydrogen gas in the first compression chamber 31S is allowed to leak out of the first compression chamber 31S in consideration of the life of the piston ring 31c. For this reason, the configuration in which a leak gas is supplied to the fuel cell module 18 can contribute to generation of electric power for driving the compressor unit 1 while prolonging the life of the piston ring 31c.

In addition, since in the present embodiment, the fuel cell module 18 is used also as a power source for the refrigerant gas compressor 4a, driving of the refrigerant gas compressor 4a can be covered also by the hydrogen gas. Therefore, the refrigerant gas compressor 4a does not need to be connected to an external power source either.

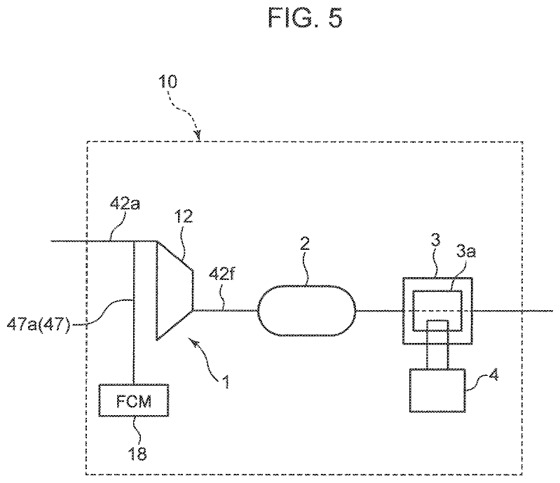

It should be understood that the embodiment disclosed herein is illustrative in all respects and is not restrictive. The present invention is not limited to the above embodiment, and various modifications, improvements, and the like can be made without departing from the gist of the present invention. For example, although in the above embodiment, the hydrogen supply flow path 47 includes the suction gas flow path 47a and the compressed gas flow path 47b, the present embodiment is not limited thereto. As shown in FIG. 5, the hydrogen supply flow path 47 may not include the compressed gas flow path 47b. Specifically, the hydrogen supply flow path 47 is connected to the suction side flow path 42a without being connected to the compressor main body 12, and supplies a hydrogen gas from the suction side flow path 42a to the fuel cell module 18. In this case, since the hydrogen supply flow path 47 includes only the suction gas flow path 47a, the hydrogen gas pump 55 of the fuel cell module 18 suctions only the hydrogen gas before being suctioned into the compression portion 21, and feeds the hydrogen gas to the FC stack 52.

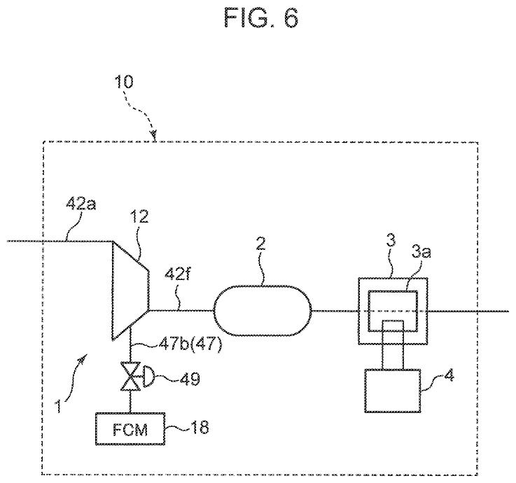

Although the above embodiment has a configuration in which a hydrogen gas pressure in the suction side flow path 42a is less than 2 MPa, the present embodiment is not limited to such a configuration. For example, the hydrogen gas pressure in the suction side flow path 42a may be about 40 MPa. In other words, the hydrogen gas pressure in the suction side flow path 42a may be 2 MPa to 40 MPa. In this case, as shown in FIG. 6, the hydrogen supply flow path 47 does not include the suction gas flow path 47a, but includes only the compressed gas flow path 47b. In this configuration, the hydrogen supply flow path 47 (the compressed gas flow path 47b) is provided with an adjusting valve 49 for adjusting the hydrogen gas pressure to a pressure suitable for specifications of the fuel cell module 18. Specifically, the hydrogen gas flowing through compressed gas flow path 47b is decompressed by the adjusting valve 49 and then supplied to the fuel cell module 18. It is possible to adopt a configuration where in a case where a hydrogen gas pressure of the leak gas from the compressor main body 12 is lower than the pressure of the hydrogen gas in the suction side flow path 42a, the hydrogen supply flow path 47 does not include the suction gas flow path 47a, but includes only the compressed gas flow path 47b.

Instead of the configuration including the crank mechanism, the compressor main body 12 may be configured by, for example, a reciprocating compressor of a hydraulic driving type, an ion hydraulic driving type, or the like. Alternatively, the compressor main body may be configured by a diaphragm reciprocating compressor. In particular, in the hydraulic driving type or the ion hydraulic driving type, a leak gas from the compression chamber can be used.

Although in the above embodiment, the compressed gas flow path 47b is connected to the distance piece 38, and the compressed gas flow path 47b supplies a hydrogen gas (leak gas) leaking from the first compression chamber 31S to the fuel cell module 18, the present embodiment is not limited thereto. For example, the compressed gas flow path 47b may be connected to the connection paths 42b to 42e to supply a hydrogen gas in the connection paths 42b to 42e to the fuel cell module 18.

The fuel cell module 18 may be used also as a motor power source for an air compressor (not illustrated) for a pneumatic instrument used in the hydrogen station 10. Furthermore, the fuel cell module may be used also as a power source for apparatuses used in the hydrogen station 10, such as a controller of the compressor unit 1, a gas detector, lighting, an air conditioner, and the like.

Here, the embodiment will be outlined.

(1) The compressor unit according to the embodiment is a compressor unit used in a hydrogen station and for compressing a hydrogen gas, the compressor unit including: a reciprocating compressor main body having a drive portion and a compression portion driven by the drive portion to compress a hydrogen gas; an electric motor that is a power source of the drive portion; a hydrogen supply flow path which is connected to a suction side flow path of the compressor main body or to the compressor main body and through which a hydrogen gas flows; a fuel cell module, disposed in the hydrogen station, for generating electric power using a hydrogen gas guided through the hydrogen supply flow path, and for supplying the generated electric power to the electric motor, and an inverter for adjusting a rotation speed of the electric motor.

In the compressor unit, electric power generated by the fuel cell module disposed in the hydrogen station is supplied to the electric motor, so that the compression portion of the compressor main body is driven using the electric motor as a power source. At this time, the rotation speed of the electric motor is adjusted by the inverter. Since the fuel cell module in the hydrogen station is used as a driving power source, it is not necessary to connect to an external power source to drive the compressor main body. Therefore, the compressor unit can be operated in the hydrogen station without being connected to an external power source. In addition, since the hydrogen gas is supplied from the suction side flow path or the compressor main body to the fuel cell module, it is not necessary to supply a hydrogen gas from outside in order to generate electric power.

(2) The compressor main body may include a supply path connection portion capable of supplying a leak gas from a compression chamber of the compression portion to the hydrogen supply flow path. In this aspect, since the leak gas from the compression chamber is supplied to the hydrogen supply flow path, a hydrogen gas that has been conventionally discarded can be effectively used for power generation.

(3) A pressure of the leak gas may be lower than a pressure of a hydrogen gas in the suction side flow path. In this case, the hydrogen supply flow path may be connected to the compressor main body without being connected to the suction side flow path, and may be configured to supply a hydrogen gas from the compressor main body to the fuel cell module.

In this aspect, since the pressure of the hydrogen gas leaking from the compression chamber is lower than the hydrogen gas pressure in the suction side flow path, the leak gas cannot be returned to the suction side flow path. However, by supplying the leak gas to the fuel cell module, the leak gas that cannot be returned to the suction side flow path can be effectively utilized for power generation in the fuel cell module.

(4) The compressor unit may further include a refrigerator that has a refrigerant gas compressor driven by a motor and cools a hydrogen gas in a dispenser. In this case, the fuel cell module may be used also as a power source for the motor of the refrigerant gas compressor.

In this aspect, driving of the refrigerant gas compressor can also be covered by the hydrogen gas. Therefore, the refrigerant gas compressor does not need to be connected to an external power source either.

As described above, the compressor unit in the hydrogen station can be operated without being connected to the external power source.

This application is based on Japanese Patent Application No. 2021-056538 filed on Mar. 30, 2021, the contents of which are hereby incorporated by reference.

Although the present invention has been fully described by way of example with reference to the accompanying drawings, it is to be understood that various changes and modifications will be apparent to those skilled in the art. Therefore, unless otherwise such changes and modifications depart from the scope of the present invention hereinafter defined, they should be construed as being included therein.

1. A compressor unit used in a hydrogen station and for compressing a hydrogen gas,
the compressor unit comprising:
a reciprocating compressor main body having a drive portion and a compression portion driven by the drive portion to compress a hydrogen gas;
an electric motor that is a power source of the drive portion;
a hydrogen supply flow path which is connected to a suction side flow path of the compressor main body or to the compressor main body and through which a hydrogen gas flows;
a fuel cell module, disposed in the hydrogen station, for generating electric power using a hydrogen gas guided through the hydrogen supply flow path, and for supplying the generated electric power to the electric motor; and
an inverter for adjusting a rotation speed of the electric motor.

2. The compressor unit according to claim 1, wherein
the compressor main body includes a supply path connection portion capable of supplying a leak gas from a compression chamber of the compression portion to the hydrogen supply flow path.

3. The compressor unit according to claim 2, wherein
a pressure of the leak gas is lower than a pressure of a hydrogen gas in the suction side flow path, and
the hydrogen supply flow path is connected to the compressor main body without being connected to the suction side flow path, and configured to supply a hydrogen gas from the compressor main body to the fuel cell module.

4. The compressor unit according to claim 1, further comprising a refrigerator that has a refrigerant gas compressor driven by a motor and cools a hydrogen gas in a dispenser,
wherein the fuel cell module is used also as a power source for the motor of the refrigerant gas compressor.
